(19) United States
(12) Patent Application Publication
(10) Pub. No.: US 2012/0262714 A1
(43) Pub. Date: Oct. 18, 2012

(54) LOW PROFILE, HIGH FLOWTHROUGH SMOKE CHAMBER

(76) Inventor: Eric V. Gonzales, Aurora, IL (US)

(21) Appl. No.: 13/084,684

(22) Filed: Apr. 12, 2011

(51) Int. Cl. G01N 21/53

(52) U.S. Cl. 356/338

(57) ABSTRACT

A low profile optical smoke chamber structure with a top cover incorporating airflow slots, an intermediate annular air channel, a depending light shield wall surrounding an interior detection chamber where the top cover is interengagable with a base member where the light shield wall is spaced from the base member so as to provide minimal deflection of ambient airflow into the detection chamber while preventing impingement of ambient light therein.

### FIELD OF THE INVENTION

The disclosed invention relates to the art of optical hazardous condition detector devices in general and a new and useful smoke chamber design optimized for directed, minimally perturbed air flow to provide improved sensitivity particularly in the case of photoelectric smoke detectors.

### BACKGROUND

Photoelectric smoke detectors usually work on the same principle but follow one of two common configurations. In one case, activation of the photoelectric detector occurs when a light focused on a light-sensitive sensor is obstructed or blocked by particulate matter in the ambient air of the type contained in smoke. The second type of detector relies on detection of scattering from a light source. In the detector's smoke chamber, light from an appropriate source impinges on and is scattered/reflected by the airborne particulates of the type resulting from a smoldering fire which is detected by a light receiving device, such as a photodiode.

To balance the need for isolation of the chamber interior from ambient light while providing airflow, several chamber designs have been advanced in the art. For example, U.S. Pat. No. 4,315,158 to Kakigi et al.; U.S. Pat. No. 5,670,947 to Nagashima; U.S. Pat. No. 5,400,014 to Behlke et al; and U.S. Pat. No. 7,365,846 to Hess et al. all illustrate a chamber incorporating a series of peripheral, nested, vanes or baffles that successfully minimize entry of ambient light into the chamber but also serve to restrict direct airflow in, through, and out of the chamber. The labyrinthine air passage introduces multiple boundary conditions that result in creation of non-laminar forces and turbulent flow.

The presence of multidirectional obstructions in an airflow path not only can create airflow cross-path interference and counter-flow conditions, but also can generate undesirable frictional forces between the baffles/vanes and the airborne particulates. Introduction of frictional forces can adversely impact the sensitivity of the detector by reducing the air flow volume and impeding the movement of airborne particles. Such interference can cause a loss of energy resulting in a number of the particles to adhere to the obstructing baffles/vanes and a concomitant loss of sensitivity. In short, traditional labyrinth-type smoke chambers by necessity, sacrifice a minimally obstructed or otherwise direct airflow path thereby causing a reduction in detection efficiency by retarding detection speed attributable to increased time for a necessary population of smoke particles to accumulate before a sufficient concentration accumulates to trigger an alarm event responsive to a fire condition.

The chamber described in U.S. Pat. No. 6,521,907 to Shoaff et al. appears to have been designed, in part to respond to the issues of airflow obstruction. That design provides a photoelectric smoke detector chamber design ostensibly providing an effective ambient light trap, an overall lower profile, and non-labyrinthine air flow path. The multi-piece chamber incorporates a cylindrical top and base where the base includes a plurality of radially extending, vertical supports annularly spaced around its interior perimeter wall. The top rests on the vertical supports and interlocks to the base. The top features a continuous, depending cylindrical wall positioned interiorly of the vertical supports. Disposed about the exterior side surface and below the top surface of the top are a series of narrow peripheral slits providing openings to a series of U-shaped air passages leading to and from the smoke sensing chamber.

The foregoing structures do not provide a substantially uninterrupted flow path for ambient air to move in and out of the sensing chamber of a photoelectric detector.

### SUMMARY OF THE INVENTION

It is an object of the invention to provide a smoke chamber design that provides a minimally obstructed air flow path for ambient air and smoke particles to quickly and efficiently enter and exit the smoke chamber.

It is another object of the invention to provide a smoke chamber structure that efficiently isolates the interior photoelectric sensing components from ambient light.

It is a further object of the invention to provide a smoke chamber design that has a minimal profile while providing maximal passive airflow.

It is a further object of the invention to provide a smoke sensing chamber with a releasably inter-engageable, two piece construction molded from thermoplastic and possessing a low profile.

These and other objects are satisfied in part by a low profile smoke chamber assembly for a photoelectric hazardous condition detector which incorporates a base member of a first select peripheral height and a cover member of a second select peripheral height, said base member and cover member being releasably interlockable to form an integrated housing having a height less than the combined heights of the first and second select heights enclosing a smoke chamber; where said base member includes a photoelectric source mounting member and a co-planar, angularly off-set sensor mounting member, each of said mounting members including feedthrough apertures for electrical communication to an adjacent surface, and where said cover member includes a substantially continuous inner wall projecting to a height greater than the second select height where said interior wall establishes a peripheral boundary of a detection chamber contained within, and an outer wall of the second select height, said outer wall including a plurality of vertically oriented airflow slots having a height less than but substantially equal to the second select height, an annulus established between said outer wall and said inner wall for communicating air from said plurality of vertically oriented airflow slots into and out of said detection chamber, said detection chamber including a light source mounting assembly and a co-planar light sensor mounting assembly angularly offset from each other.

The foregoing objects are also satisfied by a smoke chamber comprising a multi-piece cooperative structure featuring a top element and a base element, the top element including a multi-wall structure defining a vented exterior wall and a depending interior wall, the interior wall defining an interior detection chamber incorporating substantially coplanar mounting assemblies to secure at least a light source and a receptor sensor; the top element further comprising a plurality of alternating columns and gaps with a recessed pillar forming a base of each gap and slotted openings forming the sides of the gap, an annular airflow channel disposed between the slotted openings and the depending interior wall to establish a shield from entry of ambient light into the interior detection chamber while providing an airflow path with minimal obstruction for quick and efficient ingress and egress relative to the interior detection chamber.

Certain of if not all of the above stated objects are provided for by a bifurcated, low profile smoke chamber, comprising a first member and a second member, said first member and second member being interengagable to establish an interior detection chamber having a substantially open area and a select height, said chamber being shielded from impingement of ambient light by a light trap wall depending from the first member, said wall having a height less than that of the select height to provide a substantially continuous perimetric channel for ingress and egress of ambient air relative to the detection chamber, said detection chamber incorporating spaced apart, angularly offset, and substantially coplanar light source mounting means and light sensor mounting means, said first member including a substantially annular airflow path exterior of the wall and interior of an outer perimeter wall, said outer perimeter wall incorporating a plurality of perimetric airflow slots disposed at an angle substantially orthogonal to said light trap wall.

As used herein “substantially”, “relatively”, “generally”, “significantly”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawing, the methods should become evident to a person of ordinary skill in the art.

### DESCRIPTION OF THE DRAWINGS

FIG. 1 is a perspective view of an assembled smoke chamber according to the illustrated embodiment of the invention.

FIG. 2 is an assembly view of the smoke chamber of FIG. 1.

FIG. 3 is a bottom view of the cover member of the smoke chamber of FIG. 1.

FIG. 4 is a perspective bottom view of the cover member of the smoke chamber of FIG. 1.

FIG. 5 is a first perspective view of the base member of the smoke chamber of FIG. 1.

FIG. 6 is a second perspective view of the base member of the smoke chamber of FIG. 1.

FIG. 7 is a bottom view of the base member of the smoke chamber of FIG. 1.

### DESCRIPTION OF THE EMBODIMENTS

FIG. 1 illustrates a low profile smoke sensing chamber assembly 10 according to an embodiment of the invention. The assembly 10 comprises a vented top cover 12 affixed to a chamber base 14. As illustrated, the assembly 10 is cylindrical and is of a height significantly less than the assembly diameter. The top cover 12 is defined by an upper portion which is established by a planar disk-like member 16 with a plurality of perimetric, vertically disposed columns 18 with interposed vertical gaps 19 therebetween. The columns 18 and gaps 19 are concentric and depend axially almost the entire height of the top cover 12 excepting the lower edge 13. The gaps 19 extend a short distance radially inward to vertically disposed, depending pillars 17 which alternate with the columns 18. Radially oriented air flow vent passages 20 are established between the back edge of a respective column and the front edge of an adjacent pillar. Consequently, the vertical air vent passages 20 are established substantially about the entire perimeter of the top cover 12 to maximize passive, ambient airflow through the interior.

The outer perimeter of the top cover 12 also includes a plurality (three are illustrated) of barbed engaging prongs 21, part of the detachable cover and base interlock. The top cover 12 also incorporates the upper halves of bifurcated, diametrically off-set, light source and sensor mounting assembly structures. More particularly, the upper or top portion 22 of a light source mounting assembly 23 extends through the interior barrier wall 32 through the annular channel 33 and protrudes from the outer columned wall of the top cover 12.

The base 14 has a floor and is of a similar diameter and adapted to interlockingly mate with and engage the top cover 12 along the lower edge 13 with its lipped rim formed along the upper edge of the continuous outer side wall 24. The base 14 also incorporates a radially protruding lower portion of the light source mounting assembly 23. The bottom surface of the base 14 includes spacer lugs barbed mounting prongs 26 which project axially below the base floor 27 for mounting the sensing chamber 10 to an underlying printed circuit board or the like (not illustrated). The bottom surface includes a series of alignment support projections 29 which space the base 14 from an underlying structure. A plurality of recessed channels 21A, corresponding in number, size, and position of the engaging prongs 21 of the top cover 12 are axially disposed about the perimeter of the base 14 and are adapted to receive the mounting prongs 21 to interlock the base 14 to the top cover 12.

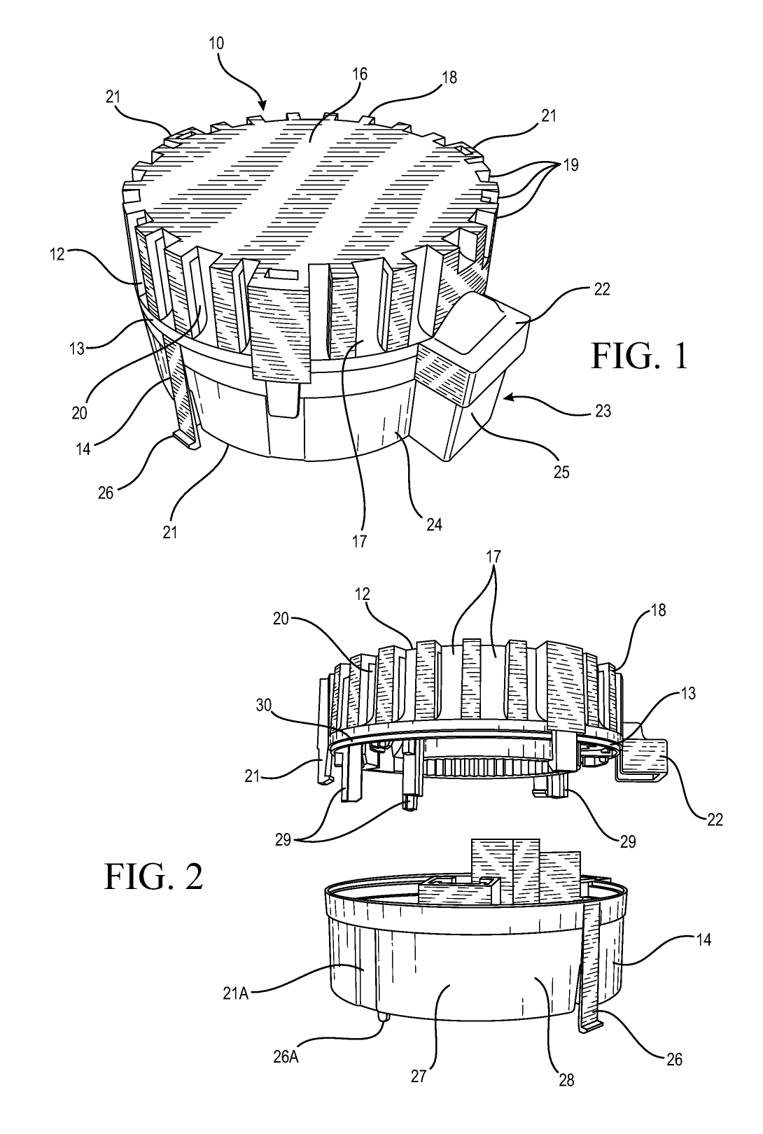

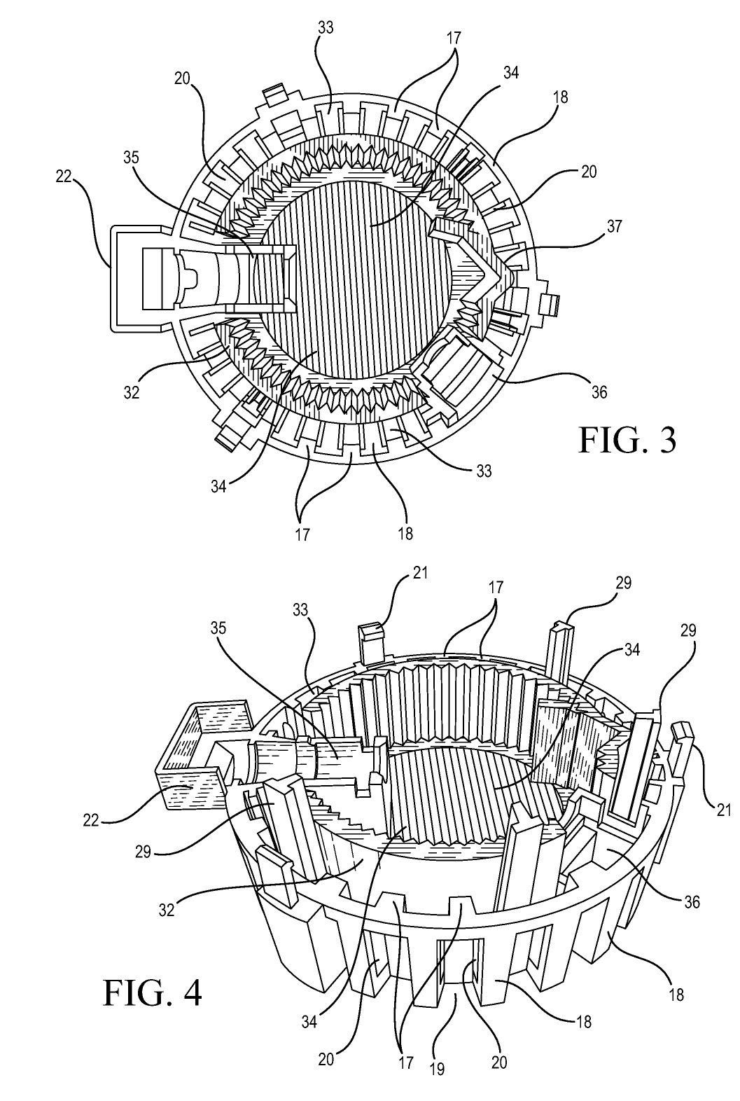

Moving to the interior structures of the chamber top cover 12 as best viewed in FIGS. 2, 3 and 4, a plurality of alignment prongs 29 (four illustrated) are located just interiorly of the lipped mounting flange 30 established by the bottoms of the concentrically spaced, alternating columns and pillars. This lipped flange forms a continuous ring (excepting the short disruption due to light source top portion 22) which serves a mounting seat of the top cover 12 to the base 14. Projecting from the bottom of the disk member 16 is a substantially continuous, interior barrier wall 32 which is disposed within the perimeter defined by the exterior wall in a manner to establish an annular air gap 33 therebetween. The air gap 33 is interrupted only by the light source housing 23, the light sensor housing 36 and the periodically space support prongs 29. The interior barrier wall 32 has a height (axial length) greater than that of the exterior wall in order to project below the plane defined by the lipped mounting flange 30 so as to prevent entry of ambient light from the air vent passages 20 into the interior of the assembled chamber. The interior barrier wall structure is intended to pose only a minimal deflecting barrier to airflow in and out of the chamber interior while preventing entry of ambient light therein. Furthermore, to minimize signal generation from spurious light reflections, the interior surfaces including the barrier wall 32 as well as the bottom surface of the disk 16 feature a serrated surface 34 again the continuity thereof being interrupted by the light source and sensor mounting assemblies and the inclusion of a light trap baffle 37 proximate to the sensor assembly.

Referring to the mounting assembly structures, the photoelectric light source mounting assembly cover 35 and the upper half of the photoelectric light sensor mounting assembly cover 36 extend from the chamber interior through the barrier wall 32. In the illustrated embodiment, all of the sensor mounting assembly 36, the diametrically opposed light source baffle 37, and the angularly off-set sensor mounting assembly 35 are disposed in a common plane underlying the circular disk-like member 16 but above the plane defined by the lower edge of the barrier wall 32. In this manner, background noise from spurious reflections is minimized.

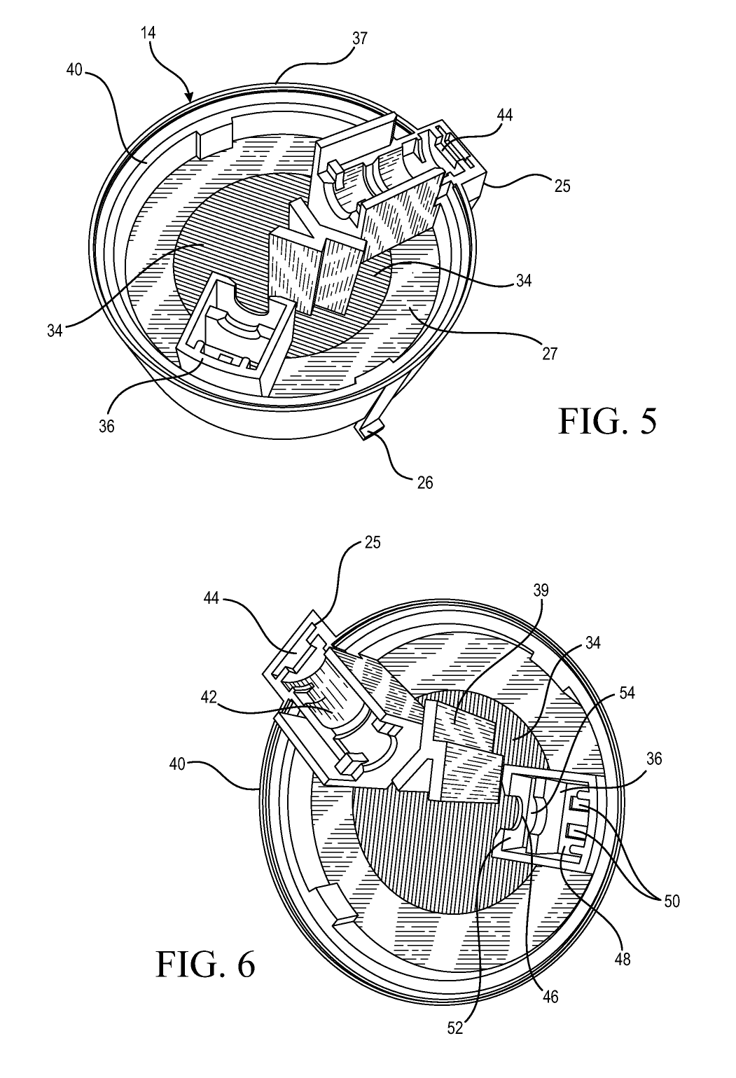

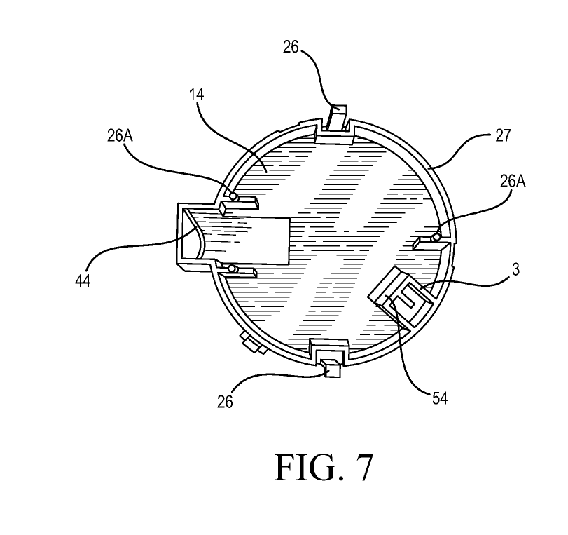

Turning now to the base 14, illustrated in FIGS. 5 through 7, its exterior defines a cylindrical cup with a floor, a side wall with a lipped rim, a plurality of spaced separation spacers 26A and a pair of PCB mounting prongs spacer supports 26. Interiorly, the base 14 incorporates the lower half 25 of the light source mounting assembly 23 and lower half of the sensor mounting assembly 36. A vertically oriented light shield baffle 39 projects above the serrated floor surface 34 to a height extending beyond the top of the source and sensor mounting assemblies to prevent direct impingement of light emitted from the source onto the off-set light sensor mounted in the chamber. The periphery of the base 14 features a vertical wall 28 axially extending above the floor 27 to its upper boundary formed by a stepped exterior wall structure comprising a perimetric mounting flange 40 having an interior step and an exterior ring for mating with and releasably engaging flanged lip 30 of the top cover 12. Upon securement of barbed prongs 21 with the base channels 21A, the light source and mounting assemblies 23 and 36 are established, the spacer support prongs 29 contact the base floor 27, the light baffle 39 projects nearly to or to the lower surface of the disk 16 of the top cover 12 and the barrier wall 32 projects below the plane of flange 40 but spaced a significant distance above the floor 27 to provide substantially unimpeded air flow communication between the annulus 33 and the interior of the smoke chamber. The structure also serves to minimize the introduction of exteriorly generated ambient light into the smoke chamber interior.

Turning now to the structure of the source mounting assembly 25, it extends from outside the chamber through and into the smoke chamber interior. The assembly securely mounts a conventional light source such as a light emitting diode (LED) in the mounting trough 42 molded to appropriate dimension. The exterior section includes a lead line feedthrough slot 44 for communicating power leads from the underlying PCB to the mounted LED. The companion, sensor assembly 36 lies in the same plane as the source assembly but angularly off set from the diameter by about 20°. The sensor assembly 36 which is wholly contained within the smoke chamber is divided into a forward sub-chamber 46 and a rearward sensor retaining sub-chamber 48. The rearward sub-chamber 48 features three feedthrough apertures through the base floor, two forward apertures 50 for wire leads and one rearward aperture for an EMF shield to ground (not illustrated). The forward sub-chamber 46 includes an interiorly facing light aperture 52 for connection thereof to the underlying electronics. The inner most portion of the mounting assembly 36 includes an underlying slot 54 formed in the base floor. The slot 54 serves as a form of dust trap to limit dust/particle accumulation on the sensor surface.

The above described smoke chamber structure is illustrated as a bifurcated assembly where each of the components is capable of being formed of an appropriate thermoplastic resin in single molding step.

Given the foregoing, it should be apparent that the specifically described embodiment is illustrative and not intended to be limiting. Furthermore, variations and modifications to the invention should now be apparent to a person having ordinary skill in the art. These variations and modifications are intended to fall within the scope and spirit of the invention as defined by the following claims.

What is claimed is:

1. A low profile smoke chamber assembly for a photoelectric hazardous condition detector, comprising:
a) a base member of a first select peripheral height and a cover member of a second select peripheral height, said base member and cover member being releasably interlockable to form an integrated housing having a height less than the combined heights of the first and second select heights enclosing a smoke chamber;
b) said base member including a photoelectric source mounting member and a co-planar, angularly off-set sensor mounting member, each of said mounting members including feedthrough apertures for electrical communication to an adjacent surface;
c) said cover member including a substantially continuous interior wall projecting to a height greater than the second select height where said inner wall establishes a peripheral boundary of a detection chamber contained within, and an outer wall of the second select height, said outer wall including a plurality of vertically oriented airflow slots having a height less than but substantially equal to the second select height, an annulus established between said outer wall and said inner wall for communicating air from said plurality of vertically oriented airflow slots into and out of said detection chamber, said detection chamber including a light source mounting assembly and a co-planar light sensor mounting assembly angularly offset from each other.

2. The low profile smoke chamber assembly according to claim 1 where the light source mounting assembly and the light sensor mounting assembly each include at least one feedthrough for communication of electrical power to a structure underlying the base member.

3. The low profile smoke chamber assembly according to claim 1 where the light sensor mounting assembly incorporates a particle/dust trap.

4. The low profile smoke chamber assembly according to claim 1 further including spurious light reflection reduction elements.

5. The low profile smoke chamber assembly according to claim 4 further where the spurious light reflection reduction elements include serrated surfaces and baffles.

6. The low profile smoke chamber assembly according to claim 1 further comprising mounting prongs projecting below the base member for mounting to an underlying printed circuit board.

7. The low profile smoke chamber assembly according to claim 1 where the base member and cover member are cylindrical and the outer wall is established by a plurality of alternating exterior columns and recessed pillars forming radially oriented air gaps therebetween.

8. A bifurcated, low profile smoke chamber, comprising:
a first member and a second member, said first member and second member being interengagable to establish an interior detection chamber having a substantially open area and a select height, said detection chamber being shielded from impingement of ambient light by a light trap wall depending from said first member, said wall having a height less than that of the select height to provide a substantially continuous perimetric channel for ingress and egress of ambient air relative to the detection chamber, said detection chamber incorporating spaced apart, angularly offset, and substantially coplanar light source mounting means and light sensor mounting means,
said first member including a substantially annular airflow path exterior of said light trap wall and interior of an outer perimeter wall, said outer perimeter wall incorporating a plurality of perimetric airflow slots disposed at an angle substantially orthogonal to said light trap wall.

9. The bifurcated low profile smoke chamber of claim 8 where surfaces of the detection chamber are serrated to minimize reflection of light from a light source.

10. The bifurcated low profile smoke chamber of claim 9 where the light source is a light emitting diode.

11. The bifurcated low profile smoke chamber of claim 8 where the light sensor mounting means includes a dust trap.

12. The bifurcated low profile smoke chamber of claim 10 where the interior detection chamber incorporates a light shield baffle projecting from said second member to trap light generated by the light emitting diode when the light is directly launched onto the interior wall.

13. The bifurcated low profile smoke chamber of claim 12 where the second member includes prongs for mounting to an underlying structure.

14. The bifurcated low profile smoke chamber of claim 8 where each of the light source mounting means and light sensor mounting means include at least one feedthrough for lead wires.

15. A smoke chamber comprising a multi-piece cooperative structure featuring a top element and a base element, the top element including a multi-wall structure defining a vented exterior wall and a depending interior wall, the interior wall defining an interior detection chamber incorporating substantially coplanar mounting assemblies to secure at least a light source and a receptor sensor;
the top element further comprising a plurality of alternating columns and gaps with a recessed pillar forming a base of each gap and slotted openings forming the sides of the gap, an annular airflow channel disposed between the slotted openings and the depending interior wall to establish a shield from entry of ambient light into the interior detection chamber while providing an airflow path with minimal obstruction for quick and efficient ingress and egress relative to the interior detection chamber.

16. The bifurcated low profile smoke chamber of claim 15 where the base element includes prongs for mounting to an underlying structure.

17. The bifurcated low profile smoke chamber of claim 16 where the base element includes a light source mounting means and a light sensor mounting means each incorporating at least one feedthrough for lead wires.
